(19) United States
(12) Patent Application Publication
(10) Pub. No.: US 2026/0036420 A1
(43) Pub. Date: Feb. 5, 2026

(54) LASER LINE SCANNER ALIGNMENT UTILIZING REFERENCE POINTS AND A COMMON DIRECTION VECTOR

(71) Applicant: The Boeing Company, Arlington, VA (US)

(72) Inventor: Mitchell S. Middleton, Seattle, WA (US)

(21) Appl. No.: 18/791,099

(22) Filed: Jul. 31, 2024

(51) Int. Cl. G01B 11/25

(52) U.S. Cl. CPC G01B 11/2504; G01B 11/2513

(57) ABSTRACT

One example provides a laser measurement system comprising an alignment artifact attached to a global reference frame. The alignment artifact has features that define corresponding reference points. A controller is configured to obtain metadata comprising expected locations of the corresponding reference points for the features within a target view during a scan. The controller is also configured to obtain a raw point cloud of the alignment artifact within a scanner reference frame. The controller is further configured to determine scanned features from the raw point cloud, and locations of corresponding scanned reference points to form a set of scanned locations. The controller is also configured to determine a transformation matrix to transform coordinates between the scanner reference frame and the global reference frame based at least upon the set of expected locations, the set of scanned locations, and a common direction vector for a plurality of laser line scanners.

### FIELD

The disclosed examples relate to aligning laser line scanners of a laser measurement system.

### BACKGROUND

Laser measurement systems can utilize a plurality of laser line scanners arranged at different perspectives to obtain two-dimensional point clouds (depth and width) of a cross-section of a scanned object. Further, a series of two-dimensional point clouds obtained from the laser line scanners with linear motion can be combined to form a three-dimensional point cloud of the scanned object.

### SUMMARY

One example provides a laser measurement system comprising an alignment artifact attached to a global reference frame. The alignment artifact has a plurality of features, where each feature defines a corresponding reference point relative to the global reference frame. The laser measurement system further comprises a plurality of laser line scanners and a controller. The controller is configured to, for at least a first laser line scanner of the plurality of laser line scanners, obtain metadata comprising a set of expected locations of the corresponding reference points for a set of features from the plurality of features. The set of features comprises at least the features of the alignment artifact that are within a target view of the first laser line scanner during a scan. The controller is also configured to obtain a raw point cloud of the alignment artifact using the first laser line scanner within a first scanner reference frame, and to determine one or more scanned features from the raw point cloud. The control is further configured to determine a location of a corresponding scanned reference point for each scanned feature of the one or more scanned features to form a set of scanned locations of the corresponding scanned reference points. The controller is also configured to determine a first transformation matrix to transform coordinates between the first scanner reference frame and the global reference frame based at least upon the set of expected locations, the set of scanned locations, and a common direction vector for the plurality of laser line scanners. The controller is further configured to store the first transformation matrix for measurement of a scanned object.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically illustrates an example laser measurement system with an object to scan.

FIGS. 2A and 2B schematically illustrate an example transformation between a scanner reference frame and a global reference frame.

FIG. 3 schematically depicts an example common direction vector for a plurality of laser line scanners.

FIG. 4 shows a block diagram of an example laser measurement system.

FIG. 5 schematically depicts an example alignment artifact for aligning laser line scanners.

FIG. 6 illustrates a flowchart of an example method for determining a transformation matrix during alignment.

FIG. 7 illustrates a flowchart of an example method for aligning a laser line scanner of a laser measurement system.

FIG. 8 illustrates a flowchart of an example method for measuring an object following alignment of a laser line scanner.

FIG. 9 shows a block diagram of an example computing system.

### DETAILED DESCRIPTION

As mentioned above, laser measurement systems utilize laser line scanners to obtain raw point clouds of a scanned object. Such laser line scanners are arranged with different locations and/or orientations to each other and the scanned object in order to scan the scanned object from different perspectives. To combine the raw point clouds from the different laser line scanners, some laser measurement systems transform the raw point clouds to a global reference frame. However, such transforms rely on a sufficiently accurate alignment of each laser line scanner relative to the global reference frame. Current methods of alignment can be inaccurate and time consuming. More particularly, the current methods find scanned planes for faces of an alignment artifact. Further, an iterative guess and check method is utilized to determine whether a transformation of the scanned planes match the geometry of the alignment artifact in the global reference frame. Such iterative guess and check methods can consume an undesired amount of compute time and/or compute resources.

Additionally, one or more of the laser line scanners may not be aligned with a system direction of travel of the laser measurement system. Such skew can result in divergent scanned data when the point clouds are transformed into the global reference frame. For example, when scanning a sphere, such skew would produce a scanned ellipsoid. Further, such divergence can increase further along the system direction of travel and may result in inaccurate measurements for the scanned object. As such, scans of long and skinny objects (e.g., an aircraft stringer) can be prone to such inaccuracies. However, the current methods of alignment do not address skew when aligning the laser line scanners.

Accordingly, examples are disclosed that relate to aligning laser line scanners utilizing reference points and a common direction vector for the laser line scanners. Briefly, the common direction vector is determined for a plurality of laser line scanners of a laser measurement system. Further, the common direction vector is mathematically used as a direction of travel for each of the plurality of laser line scanners during a scan. In such a manner, the common direction vector helps to address potential skew in the plurality of laser line scanners as will be discussed in detail below.

Additionally, when aligning a laser line scanner, an alignment artifact attached to a global reference frame is arranged in the laser measurement system. The alignment artifact comprises features that define corresponding reference points relative to the global reference frame. Further, the laser measurement system is configured to determine scanned locations of corresponding scanned reference points from a scan of the alignment artifact. Additionally, based at least upon the expected locations of the corresponding reference points and the scanned locations of the corresponding scanned reference points, a linear regression can determine a transformation matrix for the laser line scanner. This transformation matrix is utilized when the laser measurement system performs a scan for measurement. The linear regression can help to significantly reduce processing time and/or compute resources when determining a transformation matrix versus an iterative approach for finding the transformation matrix.

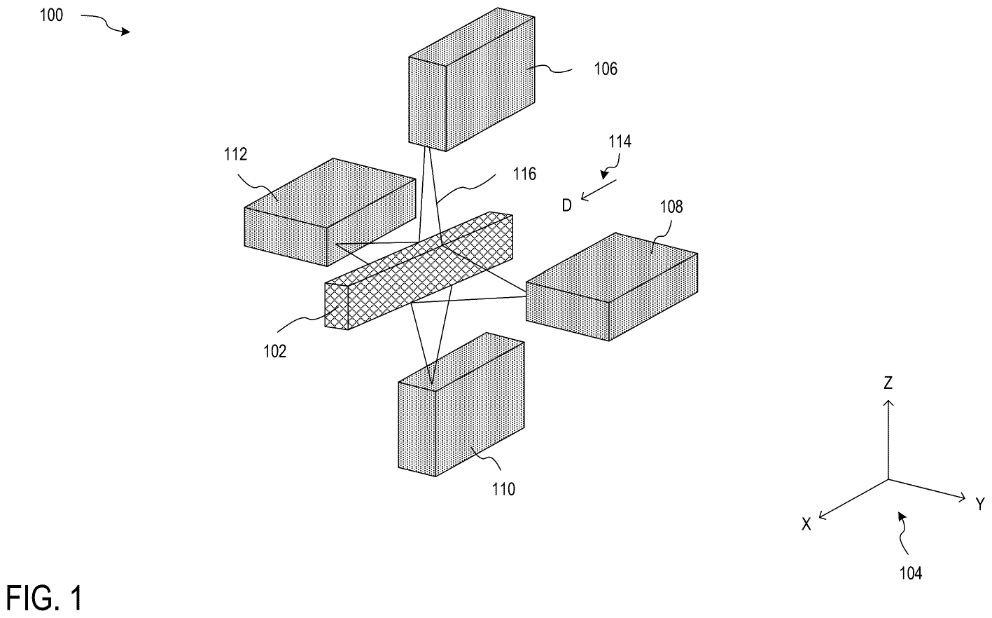

FIG. 1 schematically depicts an example laser measurement system 100 for scanning an object 102. Here, a scan of the object 102 can be utilized to measure the object 102 in three-dimensions, for example, as part of a production process. In some examples, the object 102 can comprise an aircraft part, such as a stringer. In other examples, the laser measurement system 100 can measure another suitable object. Examples of suitable objects include tubes, ducts, metal parts (e.g., aluminum, titanium, or steel parts), and composite parts (e.g., carbon fiber parts). As such, the laser measurement system 100 can have applications in the aerospace industry, the automotive industry, rail applications, maritime applications, energy fields, engineering applications, and/or other suitable applications, for example, where inspection of tolerances is required during manufacture, service, and/or inspection.

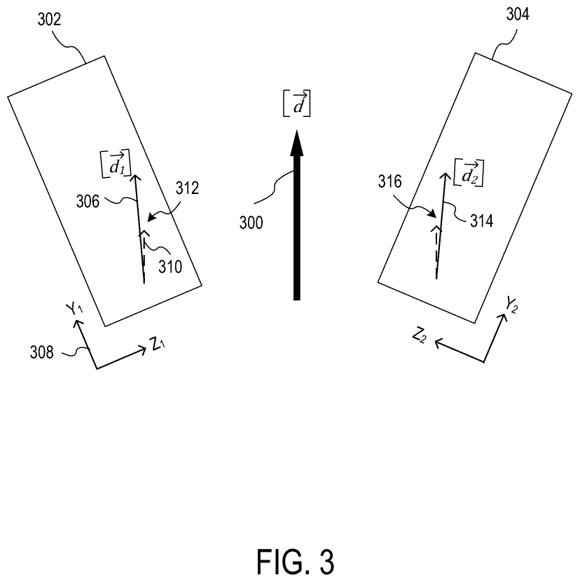

As can be seen, the object 102 is arranged relative to a global reference frame 104. Further, the laser measurement system 100 comprises a plurality of laser line scanners. FIG. 1 depicts, for the plurality of laser line scanners, a first laser line scanner 106, a second laser line scanner 108, a third laser line scanner 110, and a fourth laser line scanner 112. In other examples, a laser measurement system can include another number of laser line scanners, either fewer than or more than four. During a scan, the plurality of laser line scanners is configured to move relative to the object 102 to obtain a plurality of raw point clouds along a length of the object 102 (depicted here as along the x-axis of the global reference frame 104). This movement is mathematically expressed using a common direction vector 114 for the plurality of laser line scanners, as will be discussed with reference to FIG. 3.

During the scan, the first laser line scanner 106 obtains a first raw point cloud of the object 102 at a cross-section of the object 102 that is within a first target view 116 of the first laser line scanner 106. The first raw point cloud includes coordinates within a first scanner reference frame of the first laser line scanner 106. Likewise, the second laser line scanner 108 obtains a second raw point cloud of the object 102 within a second target view. Similarly, the third and fourth laser line scanners 110, 112 obtain corresponding raw point clouds. As previously mentioned, the raw point clouds are transformed to the global reference frame 104 for measuring the object 102. More particularly, the laser measurement system 100 is configured to transform the coordinates of the first raw point cloud to the global reference frame 104 based at least upon an alignment of the first laser line scanner 106 relative to the global reference frame 104. Likewise, the laser measurement system 100 is also configured to transform coordinates of the second, third, and fourth raw points based at least upon alignments of the corresponding second, third, and fourth laser line scanners 108, 110, 112.

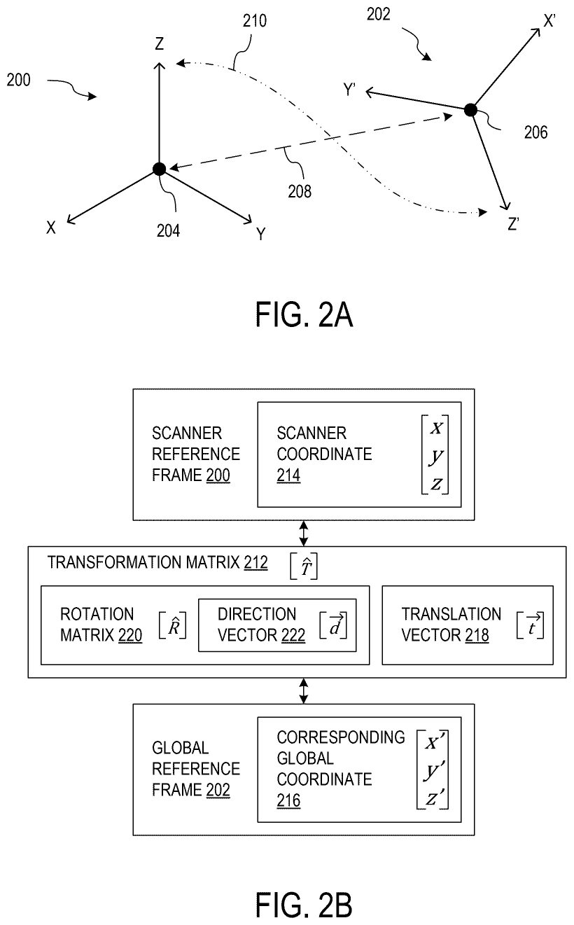

Additionally, the laser measurement system 100 is configured to align the first laser line scanner 106, the second laser line scanner 108, the third laser line scanner 110, and/or the fourth laser line scanner 112 to the global reference frame 104. These alignments are performed before a scan to measure the object 102. Briefly, during alignment of the first laser line scanner 106, a first transformation matrix of the first scanner reference frame is determined. The transformation matrix includes at least the common direction vector 114. Likewise, transformation matrices that are determined for the second, third, and fourth laser line scanners 108, 110, 112 also include at least the common direction vector 114. An example of a transformation matrix is discussed with reference to FIG. 2B. In such a configuration, the transformations from the scanner reference frames to the global reference frame 104 can have straight scanner transformations so that they are not unintentionally diverging in the global reference frame 104. Thus, the common direction vector 114 helps to address potential skew of the laser line scanners as will be discussed with reference to FIG. 3.

These alignments can be performed before each scan for measurement, and/or at another suitable interval. A suitable interval can be selected based at least upon observed alignment drift over time. For example, some conditions of a factory environment can change a position of one or more of the laser line scanners relative to each other over time, such as ambient temperature changes, for example. FIG. 1 is illustrative. In other examples, the plurality of laser line scanners may have another arrangement relative to each other. In further examples, a laser measurement system may have another configuration.

As previously mentioned, a laser measurement system is configured to transform coordinates between a scanner reference frame and a global reference frame utilizing a transformation matrix. FIGS. 2A and 2B schematically illustrate such a transformation between an example scanner reference frame 200 and an example global reference frame 202. Here, the scanner reference frame 200 reflects an orientation and a location of a laser line scanner relative to the global reference frame 202.

In FIG. 2A, the scanner reference frame 200 includes a scanner origin point 204 and vectors defining the x-, y-, and z-axes. These vectors can be expressed mathematically with [[\hat{x}][ŷ][\hat{z}]], and more specifically by the following matrix.

$${[ [ \begin{matrix}1 \\ 0 \\ 0\end{matrix} ] [ \begin{matrix}0 \\ 1 \\ 0\end{matrix} ] [ \begin{matrix}0 \\ 0 \\ 1\end{matrix} ] ]}_{scanner}$$

Likewise, the global reference frame 202 includes a global origin point 206 and vectors defining the x′, y′, and z′ axes. As can be seen, the scanner reference frame 200 has a different location for the scanner origin point 204 than the global origin point 206, depicted here with a translation line 208. Also, the scanner reference frame 200 has a different orientation than the global reference frame 202, depicted here with a rotation line 210.

In FIG. 2B, an example transformation matrix 212 is configured to transform a scanner coordinate 214 (e.g., x, y, z) to a corresponding global coordinate 216 (e.g., x′, y′, z′). The transformation matrix 212 can be used for any transformation matrix disclosed herein. Here, the transformation matrix 212 comprises a translation vector 218 based at least upon the translation line 208 from the global origin point 206 to the scanner origin point 204. This addresses a positional offset of the scanner reference frame 200 relative to the global reference frame 202. Further, the translation vector 218 can be mathematically expressed as \hat{t}=[x y z]^{T}.

The transformation matrix 212 also comprises a rotation matrix 220 based at least upon the rotation line 210 from the global origin point 206 to the scanner origin point 204. This addresses an orientation offset of the scanner reference frame 200 relative to the global reference frame 202. Additionally, the rotation matrix 220 includes a common direction vector 222. As mentioned, each transformation matrix for a plurality of laser line scanners utilizes the common direction vector 222 to help address potential skew. Generally, a direction of travel of the scanner reference frame 200 is mathematically defined along the y-axis. As such, the rotation matrix 220 comprises an x-rotation vector, the common direction vector 222, and a z-rotation vector. Mathematically, the rotation matrix 220 can be expressed with \hat{R}=[\vec{Rₓ} \vec{d} \vec{R_{z}}].

In view of the above, the transformation matrix 212 can be expressed with the following equation:

$$[ \hat{T} ] = {[ \begin{matrix}{\hat{R}}_{3 x 3} & {\vec{t}}_{3 x 1} \\ {0}_{1 x 3} & 1\end{matrix} ]}_{4 x 4}$$

In such a manner, the scanner coordinate 214 can be transformed from the scanner reference frame 200 to the global reference frame 202 to form the corresponding global coordinate 216 based at least upon the transformation matrix 212. This transformation can be mathematically expressed using the following formula: [x′ y′ z′ 1]^{T}=[\hat{T}][x y z 1]^{T}.

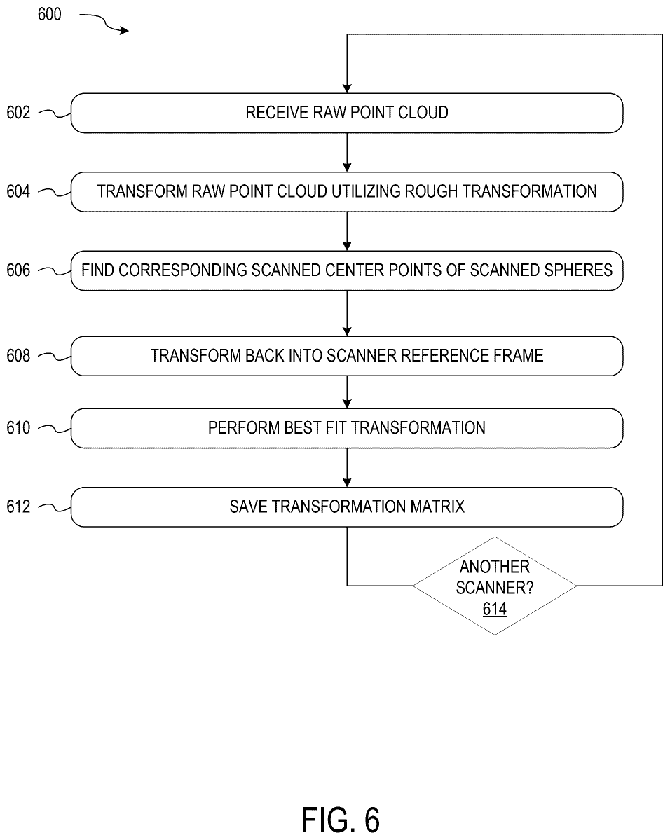

As discussed, the scanner reference frame 200 can be aligned with the global reference frame 202 before a scan for measurement. Briefly, such an alignment can determine a best fit of the translation line 208 and the rotation line 210. As used herein, the term “best fit” refers to determining one or more variables of a formula such that a value of differences between corresponding coordinates in a global reference frame and scanned coordinates in a scanner reference frame is within a desired range. An example method for determining a transformation matrix is discussed with reference to FIG. 6. FIGS. 2A and 2B are illustrative.

As previously mentioned, transformations between reference frames utilize a common direction vector to address potential skew in a plurality of laser line scanners of a laser measurement system. Specifically, a transformation matrix of a scanner reference frame utilizes the common direction vector as a y-rotation vector of a rotation matrix. Such a configuration helps to mathematically define a same direction of travel for each of the scanner reference frames. Additionally, the common direction vector for the plurality of laser line scanners can be determined during a calibration procedure of the laser measurement system. In some examples, the calibration procedure may be performed during initial installation of the laser measurement system.

FIG. 3 schematically illustrates an example common direction vector 300 for a plurality of laser line scanners. Here, the plurality of laser line scanners comprises a first laser line scanner 302 and a second laser line scanner 304. In other examples, more than two laser line scanners may be used. As depicted, the first laser line scanner 302 has a first individual direction vector 306 orientated along a y-axis of a first scanner reference frame 308. As can be seen, the first individual direction vector 306 is not aligned with a system direction of travel 310. Such misalignment results in first skew 312. Likewise, the second laser line scanner 304 has a second individual direction vector 314 that is not aligned with the system direction of travel 310 and thus, results in second skew 316. Additionally, the first individual direction vector 306 and the second individual direction vector 314 diverge away from each other and may result in skewed data when transforming raw point clouds to a global reference frame. Here, the common direction vector 300 is determined by finding an average of the first individual direction vector 306 and the second individual direction vector 314. In examples with more than two laser line scanners, the average of a corresponding plurality of individual direction vectors of a plurality of laser line scanners is found. In other examples, the common direction vector 300 may be determined in another suitable manner. FIG. 3 is illustrative.

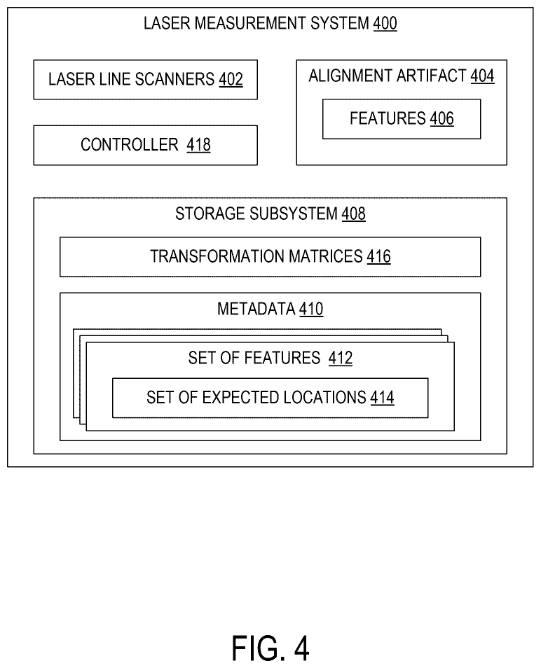

FIG. 4 illustrates a block diagram of an example laser measurement system 400. The laser measurement system 100 is an example of the laser measurement system 400. Here, a plurality of laser line scanners 402 are configured to obtain raw point clouds as discussed. Such scans can be used to measure a portion of a scanned object and/or to align at least a first laser line scanner of the plurality of laser line scanners 402.

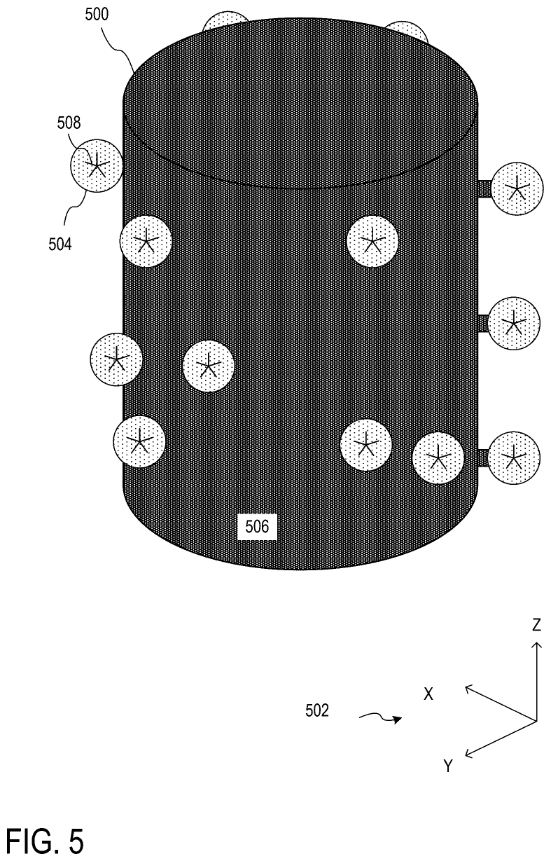

During alignment, an alignment artifact 404 attached to a global reference frame is arranged in the laser measurement system 400. The alignment artifact 404 comprises a plurality of features 406. Further, each feature of the plurality of features 406 defines a corresponding reference point. In such a configuration, a plurality of the corresponding references points is arranged at expected locations within the global reference frame. In various examples, the plurality of features 406 can include spheres, pyramids, cuboids, other polyhedrons, other suitable geometry that defines at least one corresponding reference point, and/or suitable combinations thereof. In examples using spheres, a sphere can define a corresponding center point as the corresponding reference point as discussed with reference to FIG. 5. In examples using pyramids, an apex of the pyramid can be used as the corresponding reference point.

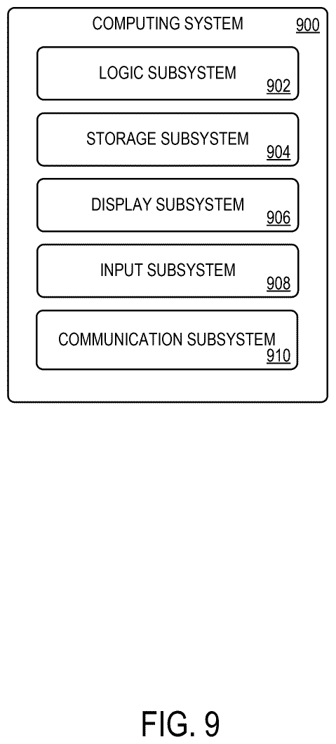

The laser measurement system 400 also includes a storage subsystem 408. Here, the storage subsystem comprises metadata 410 related to the alignment artifact 404. Specifically, the metadata 410 comprises at least one set of features 412 from the plurality of features 406 that are within a target view of the first laser line scanner. The metadata also includes a set of expected locations 414 of the corresponding reference points for the set of features 412. In the depicted example, the metadata 410 includes a corresponding plurality of the sets of features 412 for the plurality of laser line scanners 402. In other examples, metadata may have another configuration. The storage subsystem 408 also comprises a plurality of transformation matrices 416. More particularly, each transformation matrix 416 is configured to transform coordinates between a selected scanner reference frame and the global reference frame. For example, the transformation matrix 416 can take the form of the transformation matrix 212. Further aspects of the storage subsystem 408 are discussed with reference to FIG. 9.

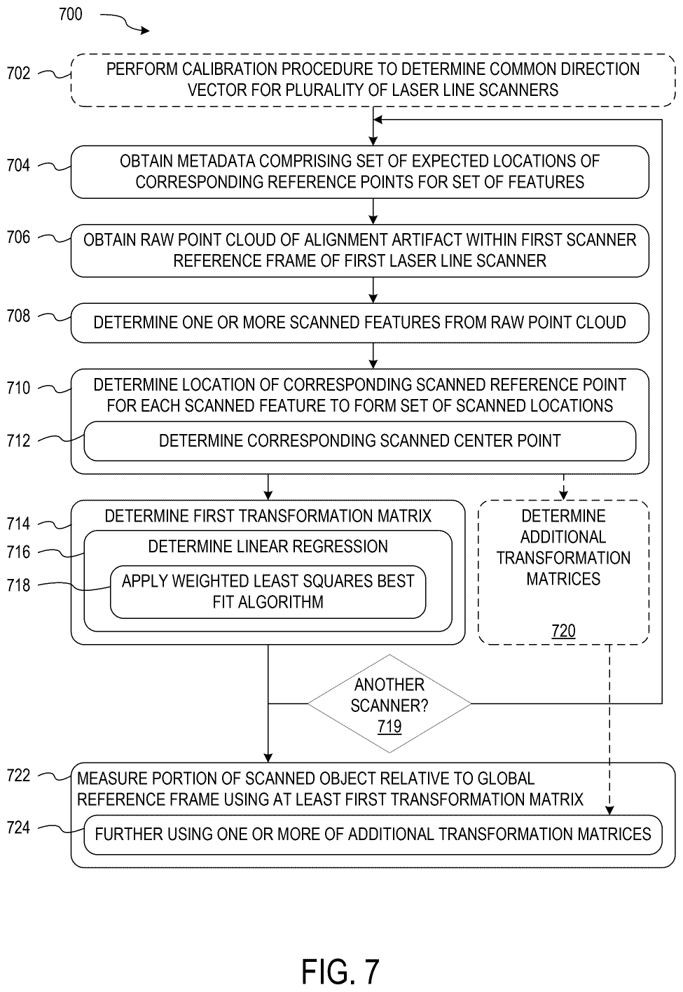

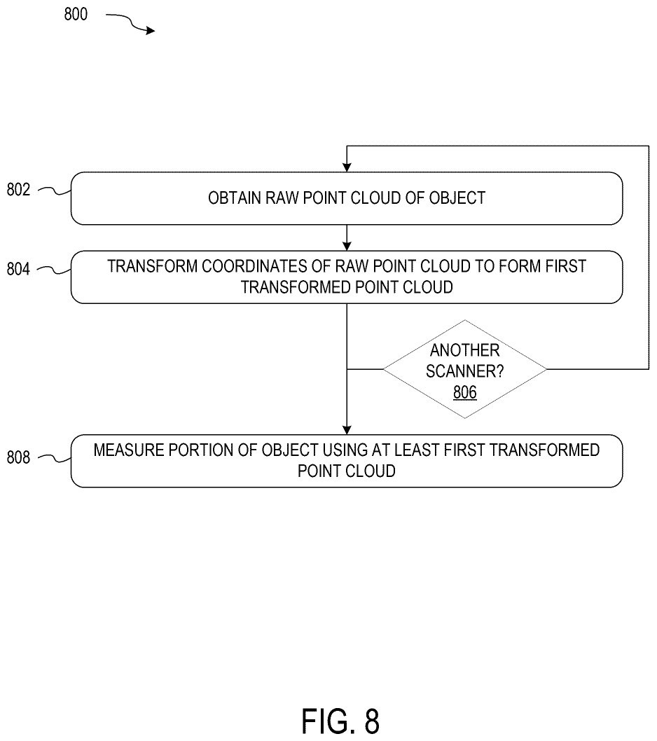

A controller 418 is configured to perform various operations of the laser measurement system 400, such as controlling the laser line scanners 402. As another example, the controller 418 is also configured to store the transformation matrix 416 found for the laser line scanner 402 selected during alignment. Briefly, the controller 418 is configured to obtain the metadata 410 pertaining to the target view of the laser line scanner 402. Further, the controller 418 is configured to form a set of scanned locations for each scanned feature found in a raw point cloud. The controller 418 is also configured to determine the transformation matrix 416 based at least upon the set of expected locations 414 and the set of scanned locations. The transformation matrix 416 is also based upon a common direction vector for the plurality of laser line scanners 402 as discussed. Example methods for alignment are discussed with references to FIGS. 6 and 7. Additionally, the controller 418 is configured to measure a portion of a scanned object utilizing the plurality of laser line scanners 402 as discussed with reference to FIG. 8. In some examples, the controller 418 can be implemented in circuits and/or firmware. In other examples, the controller 418 can be implemented as instructions executable by a processor. In such examples, the instructions for the controller 418 can be stored in the storage subsystem 408.

As previously mentioned, a laser measurement system scans an alignment artifact during alignment of one or more laser line scanners. FIG. 5 schematically depicts such an example alignment artifact 500. As depicted, the alignment artifact 500 attached to a global reference frame 502. The alignment artifact 500 comprises a plurality of features in the form of a plurality of spheres 504, such as matte tooling balls, for example. The alignment artifact 500 comprises a sufficient number of the spheres 504 such that each laser line scanner of the laser measurement system can have at least three of the spheres 504 within a target view during a scan. Additionally, the spheres 504 are arranged with positional diversity around a cylinder object 506. In other examples, a plurality of features can be arranged around other suitable geometry. Examples of suitable geometries include a center pole, a cage, a center spiral, and/or another suitable shape that holds a plurality of features in three-dimensional space.

Each sphere 504 defines a corresponding reference point in the form of a corresponding center point 508 (illustrated as a point at which five lines intersect). In such a manner, each corresponding center point 508 is arranged at an expected location relative to the global reference frame 502. Additionally, a center point may be found for a sphere that is partially within the target view of a selected laser line scanner. Such corresponding reference points can help to determine a transformation matrix with higher accuracy than utilizing scanned planes of faces for the alignment. In some examples, the alignment artifact 500 comprises similar cross-sectional dimensions to an object to be scanned for measurement. As a specific example, the cylinder object 506 can comprise a height of 4 inches and a radius of 3 inches. In some such examples, each of the spheres 504 can comprise a diameter of a half inch. FIG. 5 is illustrative. In other examples, an alignment artifact may have another configuration.

During alignment of a laser line scanner, a transformation matrix is determined based at least upon scans of the alignment artifact 500. FIG. 6 depicts a flowchart of an example method 600 for determining such a transformation matrix. The method 600 can be performed on the laser measurement system 100 or the laser measurement system 400, for example.

The method 600 comprises, at 602, receiving a raw point cloud of the alignment artifact 500 from the laser line scanner within a scanner reference frame. At 604, the method 600 comprises transforming the raw point cloud from the scanner reference frame to a global reference frame using a rough transformation. In some examples, the rough transformation can utilize a previously determined transformation matrix. In other examples, the rough transformation of the raw point cloud may be performed in another suitable manner.

The method 600 further includes, at 606, finding a plurality of corresponding scanned center points of a set of scanned spheres. As a specific example, the set of scanned spheres can be determined from the rough transformation, and can be optionally based at least upon metadata comprising a set of expected locations of the corresponding center points 508 of the alignment artifact 500 for one or more of the spheres 504. Any suitable algorithm can be used to find the corresponding scanned center points of the scanned spheres including, for example, RANSAC (random sample consensus), least square sphere fit algorithms, minimum zone sphere fit algorithms, maximum inscribed sphere fit algorithms, minimum circumscribed sphere fit algorithms, and/or suitable combinations thereof.

Returning, the method 600 comprises, at 608, transforming coordinates of the corresponding scanned center points of the scanned spheres back into the scanner reference frame. Here, the method 600 includes performing a best fit transformation between the scanner reference frame and the global reference frame, as indicated at 610. More particularly, the method 600 can use a linear regression to determine the transformation matrix based at least upon the coordinates transformed of the corresponding scanned center points and the expected locations of the corresponding center points 508 that are within a target view of the laser line scanner. In some examples, the linear regression can include a least squares best fit algorithm. In some such examples, a weighted least squares best fit algorithm can be used. In such examples, the spheres 504 can have a weighting based at least upon a proximity of the sphere 504 to the laser line scanner. Alternatively or additionally, a scan of a partial sphere may have a lower weighting than a scan of a full sphere.

As discussed with reference to FIG. 2B, a transformation matrix ([\vec{T}]) comprises a rotation matrix (\hat{R}) and a translation vector (\vec{t}). Further, the rotation matrix comprises a common direction vector (\vec{d}). As mentioned, the common direction vector is determined before the alignment. Thus, during alignment, the X- and Z-rotation vectors (\vec{X} \vec{Z}) of the rotation matrix and the translation vector (\vec{t}) are variables to be found, for example, in the following least squares best fit equation:

$${[ \begin{matrix}\vec{X} & \vec{Z} & {\vec{t}}^{T}\end{matrix} ]}^{T} = {( [ \begin{matrix}\tilde{p} \\ 1\end{matrix} ] [ \begin{matrix}{\tilde{p}}^{T} & 1\end{matrix} ] )}^{- 1} [ \begin{matrix}\tilde{p} \\ 1\end{matrix} ] {( \hat{p} - [ \begin{matrix}0 & \vec{d} & 0\end{matrix} ] p )}^{T} .$$

Here, corresponding coordinates in the scanner reference frame are represented by \hat{p}. Further, coordinates in the global reference frame are represented by p, where the x- and z-coordinates are expressed with: \tilde{p}=[pₓ p_{z}]. It will be noted that a sufficient number of reference points in both the scanner reference frame and the global reference frame can provide an overdetermined system to solve for the X- and Z-rotation vectors of the rotation matrix and the translation vector.

As can be seen, the above least squares best fit transformation is a linear algebra equation. As such, the transformation matrix can be determined with a single formula instead of the current methods of performing multiple iterative loops to find a best fit transformation. This helps to significantly decrease processing time compared to the current methods. With reference now to FIG. 6, the method 600 also comprises, at 612, saving the transformation matrix. Further, at 614, the method 600 can be configured to repeat the depicted steps to determine one or more corresponding additional transformation matrices for one or more additional laser line scanners of the laser measurement system. FIG. 6 is illustrative. In other examples, a transformation matrix may be determined utilizing another suitable equation, such as, a weighted least squares best fit formula, for example.

FIG. 7 illustrates a flowchart of an example method 700 for aligning laser line scanners of a laser measurement system. For example, the method 700 can be performed on the laser measurement system 100 or the laser measurement system 400. The method 700 optionally includes performing a calibration procedure to determine a common direction vector for a plurality of laser line scanners on the laser measurement system by averaging a corresponding plurality of individual direction vectors as indicated at 702. This helps to address potential skew in the plurality of laser line scanners as discussed. In other examples, the common direction vector can be determined in another suitable manner.

As discussed, an alignment artifact attached to a global reference frame is arranged in a laser measurement system during alignment. Further, each feature of the alignment artifact defines a corresponding reference point. Therefore, for at least a first laser line scanner, the method 700 comprises, at 704, obtaining metadata comprising a set of expected locations of the corresponding reference points for a set of features from a plurality of features of the alignment artifact. The set of features comprises at least the features of the alignment artifact that are within a target view of the first laser line scanner. At 706, the method 700 comprises obtaining a raw point cloud of the alignment artifact within a first scanner reference frame of the first laser line scanner. The method 700 also includes, at 708, determining one or more scanned features from the raw point cloud. Further, the method 700 comprises determining a location of a corresponding scanned reference point for each scanned feature of the one or more scanned features to form a set of scanned locations of the corresponding scanned reference points, as indicated at 710. In some examples, the plurality of features of the alignment artifact comprises a plurality of spheres. In such examples, determining the location of the corresponding scanned reference point for each scanned feature of the one or more scanned features comprises determining a corresponding scanned center point for each scanned sphere in a set of scanned spheres as indicated at 712. Here, the set of scanned spheres include at least the spheres that are within the target view of the first laser line scanner.

The method 700 also comprises, at 714, determining a first transformation matrix to transform coordinates between the first scanner reference frame and the global reference frame. The first transformation matrix is based at least upon the set of expected locations, the set of scanned locations, and the common direction vector. In some examples, determining the first transformation matrix comprises determining a linear regression using the set of expected locations, the set of scanned locations, and the common direction vector, as indicated at 716. For example, the linear regression can utilize one or more of the formulas discussed with reference to FIG. 6. In some such examples, determining the linear regression can comprise applying a weighted least squares best fit algorithm as indicated at 718. In some such examples, the features that are closer to the first laser line scanner may have a higher weight than features that are further from the first laser line scanner. In other examples, 716 and/or 718 may be omitted.

In some examples, the laser measurement system can further align one or more additional laser line scanners. In such examples, the method 700 is configured to loop for each additional laser line scanner to be aligned, as indicated at 719. Additionally, one or more of 704, 706, 708, or 710 may be performed in a likewise manner as discussed above for the additional laser line scanners. Therefore, the method 700 also comprises determining additional transformation matrices for each laser line scanner of a remainder of the plurality of laser line scanners as indicated at 720. As previously discussed, each of the additional transformation matrices comprises at least the common direction vector.

Additionally, the method 700 comprises, at 722, measuring a portion of a scanned object using at least the first transformation matrix. In the examples where additional transformation matrices are determined, measuring the portion of the scanned object further uses one or more of the additional transformation matrices, as indicated at 724. In such a manner, one or more of the laser line scanners of the laser measurement system can be aligned so that transforming coordinates transformed from the scanner reference frame do not unintentionally diverge over the length of the scanned object from undesired skew.

After aligning the laser line scanners, the laser measurement system can be ready to scan for measurement. FIG. 8 illustrates a flowchart of an example method 800 for utilizing the transformation matrices from the alignment of the laser line scanners. The method 800 can be performed on any suitable laser measurement systems, such as the laser measurement system 100 or the laser measurement system 400, for example. The method 800 comprises, at 802, obtaining a raw point cloud of an object using a first laser line scanner. The raw point cloud is within a first scanner reference frame of the first laser line scanner. In some examples, the object can comprise an aircraft part, such as a stringer, for example.

At 804, the method 800 comprises transforming coordinates of the raw point cloud to form a first transformed point cloud based at least upon a first transformation matrix of the first scanner reference frame. As discussed, the first transformation matrix comprises at least a common direction vector. In some examples, the method 800 can be configured to form one or more additional transformed point clouds by returning to 802, as indicated at 806. In other examples, 806 may be omitted. The method 800 also comprises, at 808, measuring a portion of the object using at least the first transformed point cloud. In examples where additional transformed point clouds are formed, measuring the portion of the object can further use one or more of the additional transformed point clouds. In such a manner, a transformation matrix comprising at least a common direction vector as disclosed herein can help address potential skew in a plurality of laser line scanners of a laser measurement system. Further, utilizing the disclosed alignment artifact with defined corresponding reference points during alignment of the plurality of laser line scanners may result in a more accurate transformation than utilizing an alignment artifact that does not define reference points.

In some embodiments, the examples described herein can be tied to a computing system of one or more computing devices. In particular, aspects of such methods and processes can be implemented as a computer-application program or service, an API, a library, and/or other computer-program product.

FIG. 9 schematically shows a non-limiting embodiment of a computing system 900 that can enact one or more of the examples described above. For example, the laser measurement system 100 and/or the laser measurement system 400 can utilize the computing system 900 to perform suitable functions.

Computing system 900 is shown in simplified form. Computing system 900 can take the form of one or more personal computers, server computers, tablet computers, network computing devices, mobile computing devices, mobile communication devices (e.g., smart phones), and/or other computing devices. In some examples, the laser measurement system 400 of FIG. 4 can comprise one or more aspects of the computing system 900.

Computing system 900 includes a logic subsystem 902, a storage subsystem 904, and an optional display subsystem 906. Computing system 900 can optionally include an input subsystem 908, a communication subsystem 910, and/or other computing-related components not shown in FIG. 9.

Logic subsystem 902 includes one or more physical devices configured to execute instructions. For example, logic subsystem 902 can be configured to execute instructions that are part of one or more applications, services, programs, routines, libraries, objects, components, data structures, or other logical constructs. Such instructions can be implemented to perform a task, implement a data type, transform the state of one or more components, achieve a technical effect, or otherwise arrive at a desired result. For example, logic subsystem 902 can be used to execute instructions to perform the method 600, the method 700, and/or the method 800. As another example, the logic subsystem 902 can be used to execute instructions to implement the controller 418 of FIG. 4.

Logic subsystem 902 can include one or more processors configured to execute software instructions. Additionally or alternatively, logic subsystem 902 can include one or more hardware or firmware logic machines configured to execute hardware or firmware instructions. Processors of logic subsystem 902 can be single-core or multi-core, and the instructions executed thereon can be configured for sequential, parallel, and/or distributed processing. Individual components of logic subsystem 902 optionally can be distributed among two or more separate devices, which can be remotely located and/or configured for coordinated processing. Aspects of logic subsystem 902 can be virtualized and executed by remotely accessible, networked computing devices configured in a cloud-computing configuration.

Storage subsystem 904 includes one or more physical devices configured to hold instructions executable by logic subsystem 902 to implement the methods and processes described herein. When such methods and processes are implemented, the state of storage subsystem 904 can be transformed—e.g., to hold different data.

Storage subsystem 904 can include removable and/or built-in devices. Storage subsystem 904 can include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 904 can include volatile, nonvolatile, dynamic, static, read/write, read-only, random-access, sequential-access, location-addressable, file-addressable, and/or content-addressable devices.

It will be appreciated by those of ordinary skill in the art, without undue experimentation, that storage subsystem 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 902 and storage subsystem 904 can be integrated together into one or more hardware-logic components. Such hardware-logic components can include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, a display subsystem 906 can be used to present a visual representation of data held by storage subsystem 904. This visual representation can take the form of a graphic user interface (GUI). As the herein described methods and processes change the data held by the storage subsystem 904, and thus transform the state of the storage machine, the state of display subsystem 906 can likewise be transformed to visually represent changes in the underlying data.

When included, a display subsystem 906 can include one or more display devices utilizing virtually any type of technology. Such display devices can be combined with logic subsystem 902 and/or storage subsystem 904 in a shared enclosure, or such display devices can be peripheral display devices.

When included, input subsystem 908 can comprise or interface with one or more user-input devices such as a keyboard, mouse, touch screen, or joystick. In some embodiments, the input subsystem 908 can comprise or interface with selected natural user input (NUI) componentry. Such componentry can be integrated or peripheral, and the transduction and/or processing of input actions can be handled on- or off-board. Example NUI componentry can include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, and without respect to the dynamic and reconfigurable communication system described above, the communication subsystem 910 can be configured to communicatively couple computing system 900 with one or more other computing devices. Communication subsystem 910 can include wired and/or wireless communication devices compatible with one or more different communication protocols. As non-limiting examples, the communication subsystem can be configured for communication via a wireless telephone network, or a wired or wireless local- or wide-area network. In some embodiments, communication subsystem 910 can allow computing system 900 to send and/or receive messages to and/or from other devices via a network such as the Internet. For example, communication subsystem 910 can be used to receive or send data to another computing system.

Further, the disclosure comprises configurations according to the following examples.

Example 1. A laser measurement system, comprising an alignment artifact attached to a global reference frame, the alignment artifact having a plurality of features, each feature defining a corresponding reference point relative to the global reference frame; a plurality of laser line scanners; and a controller configured to, for at least a first laser line scanner of the plurality of laser line scanners, obtain metadata comprising a set of expected locations of the corresponding reference points for a set of features from the plurality of features, the set of features comprising at least the features of the alignment artifact that are within a target view of the first laser line scanner during a scan, obtain a raw point cloud of the alignment artifact using the first laser line scanner within a first scanner reference frame, determine one or more scanned features from the raw point cloud; determine a location of a corresponding scanned reference point for each scanned feature of the one or more scanned features to form a set of scanned locations of the corresponding scanned reference points, determine a first transformation matrix to transform coordinates between the first scanner reference frame and the global reference frame based at least upon the set of expected locations, the set of scanned locations, and a common direction vector for the plurality of laser line scanners, and store the first transformation matrix for measurement of a scanned object.

Example 2. The laser measurement system of example 1, wherein the controller is configured to determine the first transformation matrix by determining a linear regression using the set of expected locations, the set of scanned locations, and the common direction vector.

Example 3. The laser measurement system of example 2, wherein the controller is configured to determine the linear regression by applying a weighted least squares best fit algorithm.

Example 4. The laser measurement system of example 1, wherein the first transformation matrix comprises a rotation matrix including the common direction vector.

Example 5. The laser measurement system of example 1, wherein the controller is further configured to perform a calibration procedure to determine the common direction vector by averaging a corresponding plurality of individual direction vectors of the plurality of laser line scanners.

Example 6. The laser measurement system of example 1, wherein the controller is further configured to determine additional transformation matrices for each laser line scanner of a remainder of the plurality of laser line scanners, and to store the additional transformation matrices for the measurement of the scanned object.

Example 7. The laser measurement system of example 1, wherein the plurality of features of the alignment artifact comprises a plurality of spheres.

Example 8. The laser measurement system of example 7, wherein the plurality of spheres is arranged around a cylinder object.

Example 9. The laser measurement system of example 7, wherein the controller is configured to determine the location of the corresponding scanned reference point for each scanned feature of the one or more scanned features by determining a corresponding scanned center point for each scanned sphere in a set of scanned spheres.

Example 10. A method for aligning a laser measurement system comprising a plurality of laser line scanners, the method comprising for at least a first laser line scanner of the plurality of laser line scanners, obtaining metadata comprising a set of expected locations of corresponding reference points for a set of features from a plurality of features of an alignment artifact attached to a global reference frame, the set of features comprising at least the features of the alignment artifact that are within a target view of the first laser line scanner; obtaining a raw point cloud of the alignment artifact within a first scanner reference frame of the first laser line scanner; determining one or more scanned features from the raw point cloud; determining a location of a corresponding scanned reference point for each scanned feature of the one or more scanned features to form a set of scanned locations; determining a first transformation matrix to transform coordinates between the first scanner reference frame and the global reference frame based at least upon the set of expected locations, the set of scanned locations, and a common direction vector for the plurality of laser line scanners; and measuring a portion of a scanned object using at least the first transformation matrix.

Example 11. The method of example 10, wherein determining the first transformation matrix comprises determining a linear regression using the set of expected locations, the set of scanned locations, and the common direction vector.

Example 12. The method of example 11, wherein determining the linear regression comprises applying a weighted least squares best fit algorithm.

Example 13. The method of example 10, wherein the first transformation matrix comprises a rotation matrix including the common direction vector.

Example 14. The method of example 10, further comprising performing a calibration procedure to determine the common direction vector by averaging a corresponding plurality of individual direction vectors of the plurality of laser line scanners.

Example 15. The method of example 10, further comprising determining additional transformation matrices for each laser line scanner of a remainder of the plurality of laser line scanners, and wherein measuring the scanned object further uses one or more of the additional transformation matrices.

Example 16. The method of example 10, wherein the plurality of features of the alignment artifact comprises a plurality of spheres, and wherein determining the location of the corresponding scanned reference point for each scanned feature of the one or more scanned features comprises determining a corresponding scanned center point for each scanned sphere in a set of scanned spheres.

Example 17. A laser measurement system, comprising a plurality of laser line scanners; and a controller configured to, for at least a first laser line scanner of the plurality of laser line scanners, obtain a raw point cloud of an object, wherein coordinates of the raw point cloud are within a first scanner reference frame of the first laser line scanner, transform the coordinates of the raw point cloud to form a first transformed point cloud based at least upon a transformation matrix of the first scanner reference frame, the transformation matrix comprising at least a common direction vector for the plurality of laser line scanners, and measure a portion of the object using at least the first transformed point cloud.

Example 18. The laser measurement system of example 17, wherein the controller is further configured to determine the transformation matrix of the first scanner reference frame before obtaining the raw point cloud of the object.

Example 19. The laser measurement system of example 17, wherein the controller is further configured to perform a calibration procedure to determine the common direction vector.

Example 20. The laser measurement system of example 17, wherein the object comprises an aircraft part.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A laser measurement system, comprising:
an alignment artifact attached to a global reference frame, the alignment artifact having a plurality of features, each feature defining a corresponding reference point relative to the global reference frame;
a plurality of laser line scanners; and
a controller configured to, for at least a first laser line scanner of the plurality of laser line scanners,
obtain metadata comprising a set of expected locations of the corresponding reference points for a set of features from the plurality of features, the set of features comprising at least the features of the alignment artifact that are within a target view of the first laser line scanner during a scan,
obtain a raw point cloud of the alignment artifact using the first laser line scanner within a first scanner reference frame,
determine one or more scanned features from the raw point cloud;
determine a location of a corresponding scanned reference point for each scanned feature of the one or more scanned features to form a set of scanned locations of the corresponding scanned reference points,
determine a first transformation matrix to transform coordinates between the first scanner reference frame and the global reference frame based at least upon the set of expected locations, the set of scanned locations, and a common direction vector for the plurality of laser line scanners, and
store the first transformation matrix for measurement of a scanned object.

2. The laser measurement system of claim 1, wherein the controller is configured to determine the first transformation matrix by determining a linear regression using the set of expected locations, the set of scanned locations, and the common direction vector.

3. The laser measurement system of claim 2, wherein the controller is configured to determine the linear regression by applying a weighted least squares best fit algorithm.

4. The laser measurement system of claim 1, wherein the first transformation matrix comprises a rotation matrix including the common direction vector.

5. The laser measurement system of claim 1, wherein the controller is further configured to perform a calibration procedure to determine the common direction vector by averaging a corresponding plurality of individual direction vectors of the plurality of laser line scanners.

6. The laser measurement system of claim 1, wherein the controller is further configured to determine additional transformation matrices for each laser line scanner of a remainder of the plurality of laser line scanners, and to store the additional transformation matrices for the measurement of the scanned object.

7. The laser measurement system of claim 1, wherein the plurality of features of the alignment artifact comprises a plurality of spheres.

8. The laser measurement system of claim 7, wherein the plurality of spheres is arranged around a cylinder object.

9. The laser measurement system of claim 7, wherein the controller is configured to determine the location of the corresponding scanned reference point for each scanned feature of the one or more scanned features by determining a corresponding scanned center point for each scanned sphere in a set of scanned spheres.

10. A method for aligning a laser measurement system comprising a plurality of laser line scanners, the method comprising:
for at least a first laser line scanner of the plurality of laser line scanners,
obtaining metadata comprising a set of expected locations of corresponding reference points for a set of features from a plurality of features of an alignment artifact attached to a global reference frame, the set of features comprising at least the features of the alignment artifact that are within a target view of the first laser line scanner;
obtaining a raw point cloud of the alignment artifact within a first scanner reference frame of the first laser line scanner;
determining one or more scanned features from the raw point cloud;
determining a location of a corresponding scanned reference point for each scanned feature of the one or more scanned features to form a set of scanned locations;
determining a first transformation matrix to transform coordinates between the first scanner reference frame and the global reference frame based at least upon the set of expected locations, the set of scanned locations, and a common direction vector for the plurality of laser line scanners; and
measuring a portion of a scanned object using at least the first transformation matrix.

11. The method of claim 10, wherein determining the first transformation matrix comprises determining a linear regression using the set of expected locations, the set of scanned locations, and the common direction vector.

12. The method of claim 11, wherein determining the linear regression comprises applying a weighted least squares best fit algorithm.

13. The method of claim 10, wherein the first transformation matrix comprises a rotation matrix including the common direction vector.

14. The method of claim 10, further comprising performing a calibration procedure to determine the common direction vector by averaging a corresponding plurality of individual direction vectors of the plurality of laser line scanners.

15. The method of claim 10, further comprising determining additional transformation matrices for each laser line scanner of a remainder of the plurality of laser line scanners, and wherein measuring the scanned object further uses one or more of the additional transformation matrices.

16. The method of claim 10, wherein the plurality of features of the alignment artifact comprises a plurality of spheres, and wherein determining the location of the corresponding scanned reference point for each scanned feature of the one or more scanned features comprises determining a corresponding scanned center point for each scanned sphere in a set of scanned spheres.

17. A laser measurement system, comprising:
a plurality of laser line scanners; and
a controller configured to,
for at least a first laser line scanner of the plurality of laser line scanners,
obtain a raw point cloud of an object, wherein coordinates of the raw point cloud are within a first scanner reference frame of the first laser line scanner,
transform the coordinates of the raw point cloud to form a first transformed point cloud based at least upon a transformation matrix of the first scanner reference frame, the transformation matrix comprising at least a common direction vector for the plurality of laser line scanners, and
measure a portion of the object using at least the first transformed point cloud.

18. The laser measurement system of claim 17, wherein the controller is further configured to determine the transformation matrix of the first scanner reference frame before obtaining the raw point cloud of the object.

19. The laser measurement system of claim 17, wherein the controller is further configured to perform a calibration procedure to determine the common direction vector.

20. The laser measurement system of claim 17, wherein the object comprises an aircraft part.
